(19) United States
(12) Patent Application Publication
(10) Pub. No.: US 2020/0032945 A1
(43) Pub. Date: Jan. 30, 2020

(54) An Arrangement for Forming a Freeze Plug in a Tubing

(71) Applicant: IK-NORWAY AS, Stavanger (NO)

(72) Inventors: John Erik Gotrik, Stavanger (NO); Kjetil Aamodt, Lye (NO)

(73) Assignee: IK-NORWAY AS, Stavanger (NO)

(21) Appl. No.: 15/735,786

(22) PCT Filed: May 10, 2017
(86) PCT No.: PCT/NO2017/050116

§ 371 Date: Dec. 12, 2017

(30) Foreign Application Priority Data
May 13, 2016 (NO) 20160821

(51) Int. Cl. F16L 55/103; F25D 3/10

(52) U.S. Cl. CPC F16L 55/103; F16K 49/00; F25D 3/10

(57) ABSTRACT

An arrangement is for forming a freeze plug in a tubing. The arrangement includes a first and a second displacement element adapted to be displaced within the tubing with a medium between them that is adapted to form the freeze plug. The first and the second displacement elements include, at least at a respective end portion facing the medium between them, a sensor arrangement for measuring at least one of a pressure and a temperature.

### INTRODUCTION

The present invention relates to an arrangement for forming a freeze plug in a tubing. The arrangement comprises an elongated first displacement element and an elongated second displacement element adapted to be displaced within the tubing with a medium between them that is adapted to form said freeze plug.

The present invention also relates to a method for forming a freeze plug in a tubing.

### PRIOR ART

When a tubing for conducting a fluid or gas, such as a pipeline for oil, condensate and/or gas, is to be repaired, it is necessary to temporary plug a section of the tubing. The repair may for example involve valve repair/replacement, leak repair, corrosion repair, etc. on the tubing and the operation may involve cutting out a damaged portion of the tubing and replacing it with a new portion. Accordingly, the repair operations normally involve some form of cutting and welding operation.

In regards to repairing a tubing for conduction of gas or oil, it is important to assure that the tubing to be repaired is accurately sealed from the rest of the tubing in order to avoid ignition of the gas or oil.

Prior art methods for plugging tubing rely on use of expandable displacement elements that are displaced in the tubing by means of the conduction of the fluid. Displacement elements, often denoted “pipeline pigs” or “pipeline scrapers”, are generally used in tubing operation without stopping the conduction of the fluid, for example for cleaning an inner envelope surface of the tubing or for measurements and inspection of the inner envelope surface of the tubing. A problem with prior art expandable displacement elements is that they are expensive and the supply is restricted to few suppliers.

It is known from prior art to plug a tubing by “freeze plugging” in which water or other medium is frozen to a plug. However, prior art methods for forming of such freeze plugs suffer from the disadvantage of being insufficiently controlled. Accordingly, prior art freeze plugs do not provide a plugging of the tubing with sufficient accuracy and consistency to be used in practice, in particular for pipelines for oil and gas.

Alternatively to plugging the tubing, the full length of the tubing can be evacuated. For a pipeline constituting considerable length, this operation is costly and time consuming, and is accordingly avoided if possible.

U.S. Pat. No. 4,112,706 discloses an apparatus for freezing a slug of water to form an ice plug in a section of a pipeline for hydrostatic testing purposes. The apparatus comprises connecting a sound indicator and a temperature sensor on an outside of the pipeline for determining the quality of the ice plug.

### SUMMARY OF THE INVENTION

The invention has for its object to remedy or to reduce at least one of the drawbacks of the prior art, or at least to provide a useful alternative to prior art. A first object of the invention is to provide an arrangement for forming a freeze plug in a tubing without the use of expandable displacement elements. A second object of the invention is to provide an arrangement for forming a freeze plug in a tubing with improved accuracy. A third object of the invention is to provide an arrangement for forming a freeze plug in a more cost effective manner.

These objects are achieved by means of an arrangement for forming a freeze plug in a tubing, which comprises an elongated first displacement element and an elongated second displacement element adapted to be displaced within the tubing with a medium between them that is adapted to form said freeze plug. The arrangement is characterized in that the first displacement element and the second displacement element comprise, at least at a respective end portion facing the medium between them, a sensor arrangement for measuring at least one of a pressure and a temperature.

By means of arranging the first and the second displacement elements with sensor arrangements that detect the pressure and/or the temperature on at least the end portions of the displacement elements that faces the medium to be frozen into a freeze plug, it can be determined if and when a freeze plug with sufficient quality has been formed. Thereby, the invention enables to form the freeze plug without use of expandable displacement elements within the tubing. Accordingly, cost effective displacement elements can be used for forming freeze plugs with sufficient quality.

According to an embodiment of the invention, the first displacement element and the second displacement element comprise, at each of their two end portions, a sensor arrangement for measuring at least one of a pressure and a temperature. Detection of the pressure and/or the temperature on both end portions of the displacement elements enables a more accurate determination on when the freeze plug of sufficient quality is present.

According to an embodiment of the invention, the arrangement comprises at least one or more detection devices for detecting the displacement elements within the tubing, which one or more detection devices are adapted to be positioned at the tubing at a desired location for at least one of the displacement elements.

By means of the one or more detection devices, the displacement element can be displaced to a desired position within the tubing for the formation of the freeze plug. Preferably, the arrangement comprises a plurality of detection devices. The first and second displacement members are displaced by the flow of the medium within the tubing. Accordingly, the first and second displacement members are displaced with the same speed and by detecting one of the displacement members, the position of the other displacement members can be determined by means of a single detection device.

According to an embodiment of the invention, the arrangement comprises a measuring unit adapted to receive information from the sensor arrangement and determining at least one of the pressure and the temperature of the respective end portion of the displacement elements. The measuring unit comprises means for determining the pressure and/or temperature on basis of information received from the sensor arrangement at the displacement elements.

According to an embodiment of the invention, the arrangement further comprises a freeze element adapted to be arranged around the tubing for forming the freeze plug. The freeze element comprises preferably a chamber adapted to receive a cooling medium, such as liquid nitrogen, carbon dioxide, et cetera, for solidifying the medium between the displacement elements into the freeze plug.

According to an embodiment of the invention, the arrangement further comprises a monitoring unit for collecting the measurements of the sensor arrangement and determining if a sufficient freeze plug has been formed on basis of the measurements. The monitoring unit comprises logic means from processing the measurements from the sensor arrangement.

According to an embodiment of the invention, the arrangement further comprises an elongated third displacement element, and wherein the first and the second displacement elements are adapted to be displaced within the tubing with the medium between them for forming the freeze plug, and the second and third displacement elements are adapted to be displaced within the tubing with the medium between them for forming a further freeze plug.

By means of the first, second and third displacement elements, the freeze plug and the further freeze plug are formed, which provides an improved separation of the part of the section of the tubing to be repaired.

According to an embodiment of the invention, the displacement elements comprise a contact flange for providing a contact between the displacement elements and an inner envelope surface of the tubing. The contact flange enables to essentially maintain the medium between displacement elements during the duration of freezing the medium to the freeze plug.

According to an embodiment of the invention, the method comprises
displacing an elongated first displacement element and an elongated second displacement element within the tubing with a medium between them that is adapted to form said freeze plug,
positioning the first and the second displacement element at respective parts of the tubing in between which the freeze plug is to be formed,
freezing the tubing between the first displacement element and second displacement element, thereby forming the freeze plug,
measuring at least one of the pressure and temperature on respective end portions of the displacement elements facing the medium between them, and
determining if the freeze plug has a sufficient quality on basis of a difference in at least one of the pressure and the temperature between the displacement elements.

By comparing the difference between the pressure and/or temperature at the end portion of the displacement elements facing the medium between them, the quality of the freeze plug is determined. A small difference in the pressure and/or temperature relates to a freeze plug of high quality for the purpose of plugging the tubing.

According to an embodiment of the invention, if the difference between at least one of the pressure and the temperature at an end portion of the first displacement element facing the freeze plug and a corresponding end portion of the second displacement element facing the freeze plug is less than a threshold value, it is determined that a freeze plug with sufficient quality has been formed. The determination on the quality of the freeze plug is preferably done on basis if the difference is below a threshold value.

According to an embodiment of the invention, the method comprises
displacing the first displacement element and the second displacement element within the tubing with the medium between them for forming the freeze plug, and displacing the second displacement element and an elongated third displacement element with the medium between them for forming a further freeze plug.

### BRIEF DESCRIPTION OF THE DRAWING

In the following are described examples of preferred embodiments illustrated in the accompanying drawings, wherein:

FIG. 1 discloses an arrangement for forming a freeze plug in a tubing according to an embodiment of the invention;

FIG. 2 discloses an example of a displacement element of the arrangement in FIG. 1;

FIG. 3 discloses a flowchart of a method for forming a freeze plug in a tubing according to an embodiment of the invention.

### DETAILED DESCRIPTION

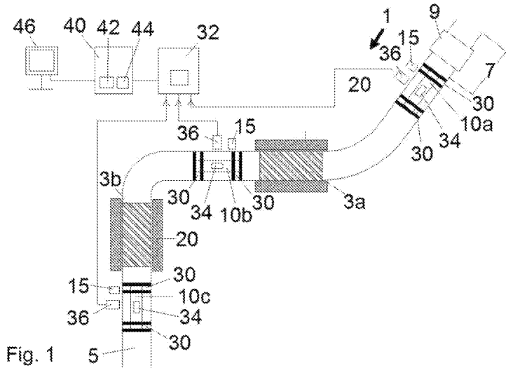

In FIG. 1 an arrangement 1 for forming a freeze plug 3a in a tubing 5 according to an embodiment of the invention is disclosed. The tubing 5 is for example a pipeline used for conducting oil and gas.

A section 7 of the tubing 5 is to be repaired. In FIG. 1, for illustration purposes the repair depicted in this case relates to replacement of a damaged valve 9 on the tubing with a new valve. Before initiating repair operation, the section 7 of the tubing 5 needs to be isolated from the rest of the tubing 5. In FIG. 1, the section 7 of the tubing is isolated from the tubing by means of forming the freeze plug 3a and a further freeze plug 3b.

The arrangement 1 comprises an elongated first displacement element 10a, an elongated second displacement element 10b and an elongated third displacement element 10c. The displacement elements 10a, 10b, 10c are adapted to be displaced within the tubing 5 with a medium between them. The medium is adapted to be frozen into the freeze plug 3a and the further freeze plug 3b. The medium is preferably water. However, another medium, such as oil, may also be solidified to form the freeze plug.

The displacement elements 10a, 10b, 10c are often denoted “pipeline pigs” or “pipeline scrapers” and are used in tubing operations. The displacement elements 10a, 10b, 10c are displaced within the tubing 5 by means of a flow of the medium through the tubing 5.

The arrangement 1 further comprises detection devices 15 for detecting the displacement elements 10a, 10b, 10c within the tubing 5. The detection devices 15 are positioned at the tubing 5 on desired locations for the displacement elements 10a, 10b, 10c within the tubing 5. The detection devices 15 comprise for example a sensor that detects the displacement elements 10a, 10b, 10c on basis of magnetic field, radio-transmission, ultra sound, et cetera.

When the displacement elements 10a, 10b, 10c have been positioned in their desired locations in the tubing 5, a respective freeze element 20 is arranged at the location between the first and the second displacement elements 10a, 10b for forming the freeze plug 3a, and between the second and the third displacement elements 10b, 10c for forming a further freeze plug 3b. The freeze element 20 comprises a chamber adapted to receive a cooling medium, such as liquid nitrogen, carbon dioxide, et cetera, for solidifying the medium between the displacement elements 10a, 10b, 10c.

Each of the displacement elements 10a, 10b, 10c comprises a respective sensor arrangement 30 at their end portions for detecting pressure and a temperature. The arrangement 1 further comprises a measuring unit 32 adapted to receive information from the sensor arrangements 30 and determining the pressure and the temperature of the respective end portion of the displacement elements 10a, 10b, 10c.

The information from the sensor arrangements 30 is transmitted through the tubing 5 by means of radio communication or other wireless means of communication. The displacement elements 10a, 10b, 10c comprise a respective transmitter 34 for transmitting information to a respective receiver 36 at the outside of the tubing 5. The measuring unit 32 is connected to the receiver 36 and is adapted to receive pressure and temperature information from the sensor arrangements 30.

The arrangement 1 further comprises monitoring unit 40 for collecting the measurements of the sensor arrangements 30 and determining if a sufficient freeze plug 3a and further freeze plug 3b have been formed on basis of the measurements. The monitoring unit 40 comprises for example a logic unit 42, such as a CPU, and means for storing data 44, such as a hard disc drive. Preferably, the arrangement also comprises a display unit 46 for displaying the pressure and the temperature, and the determination on the quality of the freeze plug 3a and further freeze plug 3b.

The determinations on the quality of the freeze plug 3a and further freeze plug 3b are made on basis of difference between the measurements on different ends of the freeze plug 3a and the further freeze plug 3b. In particular, the determination is based on if the difference between measurements below a threshold value.

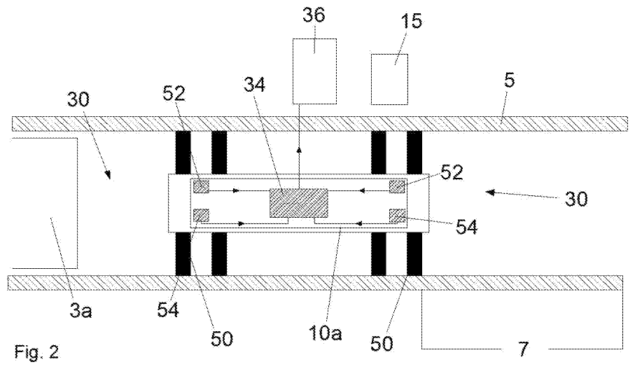

In FIG. 2, an example of the first displacement element 10a of the arrangement 1 in FIG. 1 is disclosed in further details. Preferably, the second and third displacement element 10b, 10c are provided with the corresponding features. The first displacement element 10a is arranged within the tubing 5.

The first displacement element 10a comprises an elongated form comprising two opposite end portions. In the disclosed example, one of the end portions is facing the freeze plug 3a and the other end portion is facing the section 7 of the tubing 5 to be repaired.

The first displacement element 10a comprises a respective contact flange 50 at the two end portions. The contact flange 50 has the function of providing a contact between the first displacement element 10a and an inner envelope surface of the tubing 5. The contact flange 50 of the first displacement element 10a enables the medium to essentially be maintained between two adjacent displacement elements 10a, 10b, 10c during the duration of freezing the medium to the freeze plug 3a or the further freeze plug 3b.

The first displacement element 10a comprises two sensor arrangements 30 arranged in respective end portions. In the disclosed embodiment, the sensor arrangements 30 are contained within the displacement element 10a. The sensor arrangements 30 comprise a pressure sensor element 52 and a temperature sensor element 54. The sensor elements 52, 54 are connected to the transmitter 34 that is adapted to transmit information on the pressure and temperature measurements to the receiver 36 outside the tubing 5.

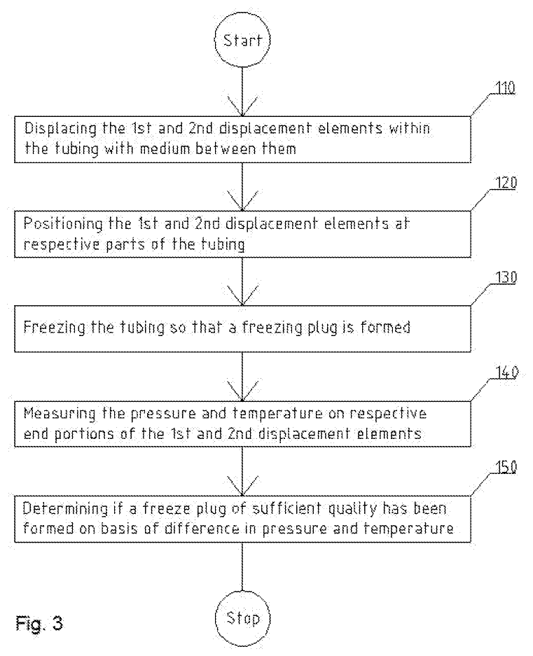

In FIG. 3 a flowchart of a method for forming a freeze plug 3a in a tubing 5 according to an embodiment of the invention is disclosed.

In a step 110, the method comprises displacing the first and the second displacement elements 10a, 10b within the tubing 5 with a medium between them. The displacement is done by means of a flow of the medium. The displacement comprises first arranging the first displacement element 10a in a launcher and introducing the first displacement element in the tubing. After the first displacement element 10a has been displaced a certain length within the tubing 5, the second displacement element 10b is arranged in the launcher and introduced in to the tubing 5.

In a step 120, the method comprises positioning the first and the second displacement elements 10a, 10b at respective parts of the tubing in between which the freeze plug 3a is to be formed. Preferably, at least one of the first and second displacement elements 10a, 10b are detected by means of one or more detection devices 15 arranged at the outside of the tubing 5.

In a step 130, the method comprises freezing the tubing 5 between the first and the second displacement element 10a, 10b. Thereby freeze plug 3 is formed. The tubing is preferably frozen by means of arranging a freeze element 20 at the outside of the tubing 5.

In a step 140, the method comprises measuring the pressure and/or the temperature on respective end portions of the first and second displacement elements 10a, 10b, which end portions facing the medium between them.

In a step 150, the method comprises determining if a freeze plug 3a of sufficient quality has been formed on basis of a difference in at least one of the pressure and the temperature between the displacement elements 10a, 10b. Preferably, the determination is based on if the difference between the pressure and/or the temperature is less than a threshold value.

In case when the further freeze plug 3b is formed between the second and third displacement elements 10b, 10c, the quality of the further freeze plug 3b can determined in a corresponding manner to the determination of the freeze plug 3a.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

1. An arrangement for forming a freeze plug in a tubing, the arrangement comprising:
an elongated first displacement element and an elongated second displacement element adapted to be displaced within the tubing with a medium between them that is adapted to form said freeze plug,
wherein the first displacement element and the second displacement element comprise, at least at a respective end portion facing the medium between them, a sensor arrangement for measuring at least one of a pressure and a temperature.

2. The arrangement according to claim 1, wherein the first displacement element and the second displacement element comprise, at each of their two end portions, a sensor arrangement for measuring at least one of a pressure and a temperature.

3. The arrangement according to claim 1, wherein the arrangement comprises one or more detection devices for detecting the displacement elements within the tubing, which one or more detection devices are adapted to be positioned at the tubing at a desired location for at least one of the displacement elements.

4. The arrangement according to claim 1, wherein the arrangement comprises a measuring unit adapted to receive information from the sensor arrangement and determining at least one of the pressure and the temperature of the respective end portion of the displacement elements.

5. The arrangement according to claim 1, wherein the arrangement further comprises a freeze element adapted to be arranged around the tubing for forming the freeze plug.

6. The arrangement according to claim 1, wherein the arrangement further comprises a monitoring unit for collecting the measurements of the sensor arrangement and determining if a sufficient freeze plug has been formed on basis of the measurements.

7. The arrangement according to claim 1, wherein the arrangement further comprises an elongated third displacement element, and wherein the first and the second displacement element are adapted to be displaced within the tubing with the medium between them for forming the freeze plug, and the second and third displacement element are adapted to be displaced within the tubing with the medium between them for forming a further freeze plug.

8. A method for forming a freeze plug in a tubing, the method comprising:
displacing an elongated first displacement element and an elongated second displacement element within the tubing with a medium between them that is adapted to form said freeze plug,
positioning the first displacement element and the second displacement element at respective parts of the tubing in between which the freeze plug is to be formed,
freezing the tubing between the first displacement element and second displacement element, thereby forming the freeze plug,
measuring at least one of the pressure and temperature on respective end portions of the displacement elements facing the medium between them, and
determining if the freeze plug has a sufficient quality on basis of a difference in at least one of the pressure and the temperature between the displacement elements.

9. The method according to claim 8, wherein if the difference between least one of the pressure and the temperature at an end portion of the first displacement element facing the freeze plug and a corresponding end portion of the second displacement element facing the freeze plug is less than a threshold value, it is determined that a freeze plug with sufficient quality has been formed.

10. The method according to claim 8, wherein the method comprises
displacing the first displacement element and the second displacement element within the tubing with the medium between them for forming the freeze plug, and displacing the second displacement element and an elongated third displacement element with the medium between them for forming a further freeze plug.
